(19) United States
(12) Patent Application Publication
(10) Pub. No.: US 2013/0198341 A1
(43) Pub. Date: Aug. 1, 2013

(54) SYSTEM AND METHOD FOR DELIVERING SEGMENTED CONTENT

(71) Applicant: Electronics and Telecommunications Research Institute, Daejeon-si (KR)

(72) Inventor: Jeong-Yun KIM, Daejeon-si (KR)

(73) Assignee: Electronics and Telecommunications Research Institute, Daejeon-si (KR)

(21) Appl. No.: 13/724,693

(22) Filed: Dec. 21, 2012

(30) Foreign Application Priority Data
Jan. 31, 2012 (KR) 10-2012-0010014

(51) Int. Cl. H04L 29/08

(52) U.S. Cl. CPC H04L 67/26
USPC 709/219

(57) ABSTRACT

A method for delivering segmented content in a user device is provided, and the method includes searching for one or more Content Delivery Network (CDN) servers in which content segments of content to be requested are distributed and stored, requesting content segments from each of the one or more found CDN servers, and receiving the content segments from the one or more found CDN servers.

### CROSS-REFERENCE TO RELATED APPLICATION

This application claims the benefit under 35 U.S.C. §119(a) of Korean Patent Application No. 10-2012-0010014, filed on Jan. 31, 2012, the disclosure of which is incorporated by reference in its entirety for all purposes.

### BACKGROUND

1. Field

The following description relates to a technology for content providing service, and more particularly, to an apparatus and a method for storing content on Content Delivery Network (CDN) server and delivering the same to a user device.

2. Description of the Related Art

In recent years, smart terminals have become widely used and demands for providing content through the smart terminals have increased. Content delivery speed plays a key role in content delivery. However, if a user device requests content when the user device is at a distance from a content providing server, content delivery time is delayed due to the long distance. In addition, a server state (for example, an overloaded state) and a network state (for example, traffic congestion) may reduce content delivery quality.

These days, in order to enhance a speed of delivering content to the user device, CDN servers are installed on a network of Internet Service Provider (IPS), helping a user to access the CDN servers more easily. Specifically, a CDN is configured such that a plurality of CDN servers are installed on an ISP network, that content provided by a content provider (CP) is pre-stored in the CDN servers and that, in response to a user's request, requested content is delivered to the user. In other words, the delivery speed becomes boosted as the content is placed adjacent to the user in advance. The arrangement of the CDN servers on the ISP network depends on an operator's policy taking into account of local environment, for example, local coverage and population density. But, the above-described method leads a plurality of CDN servers to store the same content, so that storage capacity of the CDN servers may be wasted. The redundant storage of content causes increasing server costs, especially on a large ISP network.

### SUMMARY

The following description relates to a system and a method for maintaining content delivery speed without storing the same content in a plurality of CDN servers.

The following description relates to a system and a method for delivering segmented content (content segments) on content delivery network so as to reduce server costs.

The present invention uses a content segmentation scheme. At this time, the arbitrary number of content segments is generated by dividing the content by an arbitrary size, and the content is able to be delivered on a content segment basis.

In one general aspect of the present invention, a method for providing content routing information to deliver content in a service request routing system within a network comprising one or more Content Delivery Network (CDN) servers in which segmented content is distributed and stored is provided, and the method includes receiving a content request message from a user device; searching for one or more CDN servers in which content segments of requested content are distributed and stored; and delivering content routing information which includes IP addresses of the one or more found CDN servers and information about the content segments to the user device.

In another general aspect of the present invention, a method for delivering content is provided, and the method includes requesting the content segments from CDN servers using content routing information received from a service request routing system; and receiving the content segments from the CDN servers.

In another general aspect of the present invention, a system for delivering content is provided, and the system includes Content Delivery Network (CDN) servers configured to respectively store content segments, and, in response to receiving a content request from a user device, deliver a corresponding content segment to the user device; and a service request routing system configured to manage IP addresses of the CDN servers, in which the content segments are stored respectively, and, in response to the content request received from the user device, transmit content routing information including the IP addresses of the CDN servers and information about the content segments to the user device.

### BRIEF DESCRIPTION OF THE DRAWINGS

FIG. 1 is a diagram illustrating content delivery network according to an embodiment of the present invention;

FIG. 2 is a diagram illustrating content delivery within the same network according to an embodiment of the present invention;

FIG. 3 is a diagram illustrating content delivery within two or more different networks according to another embodiment of the present invention;

FIG. 4 is a flowchart illustrating a method for delivering segmented content in a service request routing system according to an exemplary embodiment of the present invention;

FIG. 5 is a flowchart illustrating a method for delivering a content segment to a user device in the service request routing system according to an exemplary embodiment of the present invention; and

FIG. 6 is a flowchart illustrating a method for storing a content segment according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be suggested to those of ordinary skill in the art. Descriptions of well-known functions and structures are omitted to enhance clarity and conciseness.

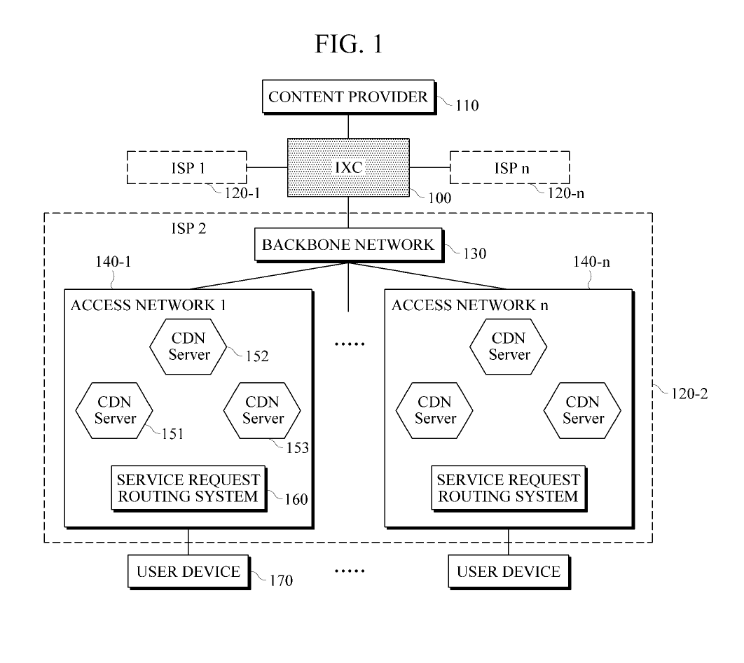

FIG. 1 is a diagram illustrating content delivery network according to an embodiment of the present invention.

Referring to FIG. 1, the content delivery network is configured such that a content provider (CP) 110 and a plurality of ISPs (Internet Service Provider) 120-1, . . . , 120-n are connected to each other through an IXP (Internet Exchange Point) 100.

The IXP 100 provides a connection necessary for delivering and uploading content between the content provider 110 and Internet operators 120-1, . . . , 120-n.

The content provider 110 generates and provides content. Specifically, according to an exemplary embodiment of the present invention, the content provider 110 distributes and stores the content in one or more Content Delivery Network (CDN) servers which are adjacent to a user device, thereby reducing service delay time and alleviate overloading. At this time, the first content segment is stored in every CDN server which stores the corresponding content, and other content segments are distributed and stored in different CDN servers. Hence, while the first content is being received, other content may be processed to be delivered, so that the delivery speed can be maintained.

Specifically, the ISPs 120-1, . . . , 120-n consist of a backbone network 130 and a plurality of networks 140-1, . . . , 140-n connected with each other via the backbone network 130.

The networks 140-1, . . . , 140-n provide Internet connection to the user device 170, so that the user device 170 get access to information inside and outside of the networks. In addition, the networks 140-1, . . . , 140-n include a plurality of CDN severs 151, 152 and 153 and a service request routing system 160.

The CDN servers 151, 152 and 153 store content provided by the content provider 110 through the backbone network 130. According to an exemplary embodiment of the present invention, the CDN servers 151, 152 and 153 store content segments of the provided content. In response to a request for the content, the CDN servers 151, 152 and 153 deliver the corresponding content segments to the user device 170.

The service request routing system 160 stores content routing information including location information of the CDN servers, in which the content segments are stored. In response to a request from the user device 170, the service request routing system 160 provides IP addresses of the CDN servers and information about the content segments to the user device 170. More specifically, the user device 170 requests the IP addresses of the CDN servers and the information about the content segments from the service request routing system 160, and obtains the IP addresses of the CDN servers and the information about the content segments. Based on the IP addresses and the information obtained from the service request routing system 160, the user device 170 transmits a content request message including information about the content to the CDN servers 151, 152 and 153 in which the content segments are stored, and then receives the content. For example, the content request message may include content routing information which may include IP addresses of CDN servers, a content title, a content playback range and a title of a content segment. At this time, a specific content playback range may be presented when the CDN servers are requested for content delivery. For example, the content playback range may be 0˜1,000 Byte. In another example, the content playback range may be given as a content segment name (a name is designated for each of the content segments). If there is no specific display, it is determined that the first segment to the last segment of the content is available to be requested. The user device 170 starts a service request for a next segment (or a next playback range) of a received content. The service request routing system 160 which has received the request repeats the above-described operation until the last segment is received.

At this time, the user device 170 is able to request the second content segment to the last content segment in sequence before receiving the first content segment.

Meanwhile, a method for distributively storing segmented content may be various according to an operator in consideration of costs. Hereinafter, there will be provided one embodiment where content segments of content are stored in CDN servers belonging to the same network and another embodiment where the content segments are stored in CDN servers belonging to different networks.

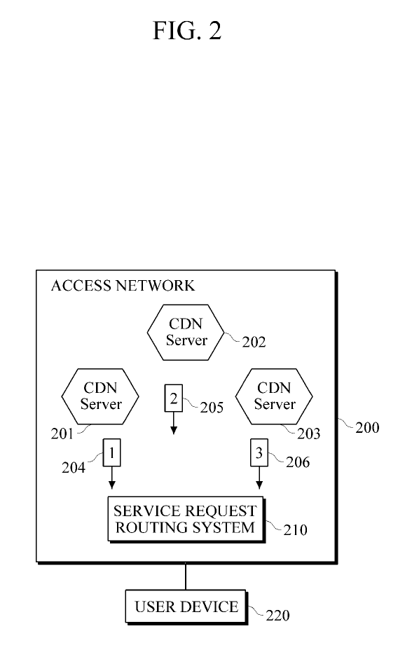

FIG. 2 is a diagram illustrating content delivery within the same network.

Referring to FIG. 2, three CDN servers 201, 202 and 203 exist on an network 200, and the CDN servers 201, 202 and 203 store content segment 1 204, content segment 2 205 and content segment 3 206, respectively.

In order to request content delivery from the CDN servers 201, 202 and 203, a user device 220 obtains content routing information from a service request routing system 210, and transmits a content delivery request to the CDN servers 201, 202 and 203.

In response, the CDN server 201 delivers the content segment 1 204. The user device 220 which has received the content segment 1 204 requests for delivering the content segment 2 205. In response, the CDN server 202 delivers the content segment 2 205 to the user device. The same process is applied when requesting and delivering the content segment 3 206.

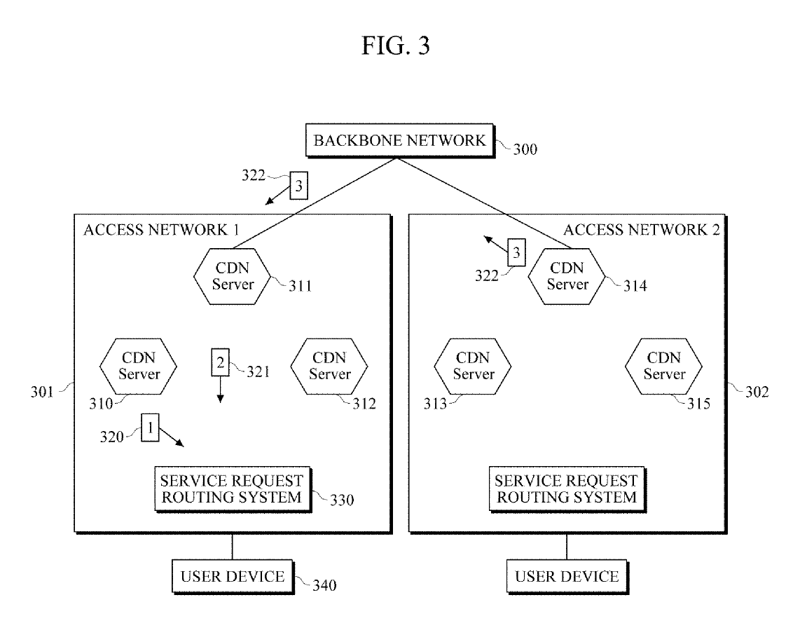

FIG. 3 is a diagram illustrating content delivery within two or more different networks according to an embodiment of the present invention.

Referring to FIG. 3, three content segments 320, 321 and 322 are distributed and stored in three CDN servers 310, 311 and 314 belonging to two networks 301 and 302. A user device 340 transmits a content request message to the CDN servers 310, 311 and 314. To this end, the user device 340 obtains content routing information from a service request routing system 330, and transmits a content request message to the corresponding CDN server 310 for delivery of content segment 1 320. In response, the CDN server 310 delivers the content segment 1 320 through the service request routing system 330 to the user device. The user device 340 which has received the content segment 1 320 requests delivery of the content segment 2 321 and the content segment 3 322.

That is, the user device 340 transmits the content request message for delivery of the content segment 2 321 and the content segment 3 322 to the CDN server 311 using the content routing information obtained from the service request routing system 330. In response, the CDN server 311 delivers the content segment 2 321. The user device 340 which has received the content segment 2 321 requests delivery of the content segment 3 322. That is, using the content routing information obtained from the service request routing system 330, the user device 340 transmits the content request message to the CDN server 314 in the network 2 302 for delivery of the content segment 3 322. In response, the CDN server 314 delivers the content segment 3 322 through a backbone network 300.

Hereinafter, a method for delivering segmented content within the above-described content delivery network will be provided.

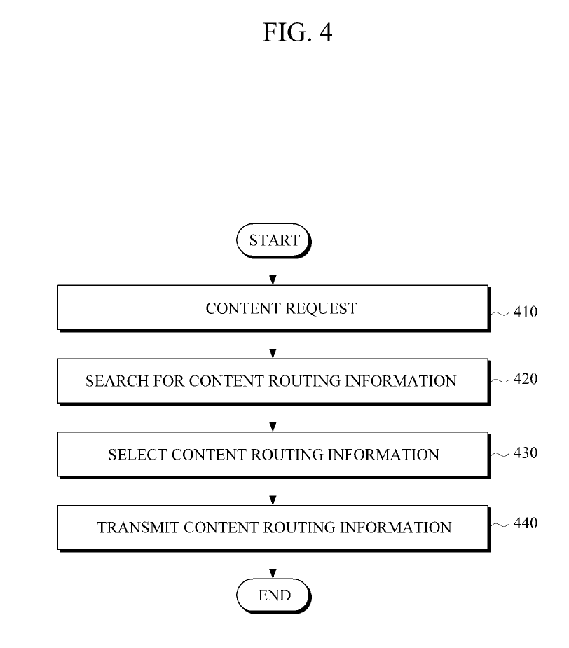

FIG. 4 is a flow chart illustrating a method for providing content routing information to deliver content segments in a service request routing system according to an exemplary embodiment of the present invention.

Referring to FIG. 4, the service request routing system receives from a user device a content request message for delivery of predetermined content in operation 410. In operation 420, the service request routing system searches for content routing information which indicates the relationship between content segments of the content requested by the user device and CDN servers in which the content segments are distributed and stored. At this time, if the found content routing information does not address the requested content, other content routing information corresponding to the requested content is searched in real time. Taking into consideration the distance and the delivery speed between the user device and each CDN server, the service request routing system, in operation 430, selects content routing information which includes IP addresses of CDN servers, in which the content segments are stored distributed and, and information about the content segments. In operation 440, the service request routing system transmits the selected content routing information to the user device.

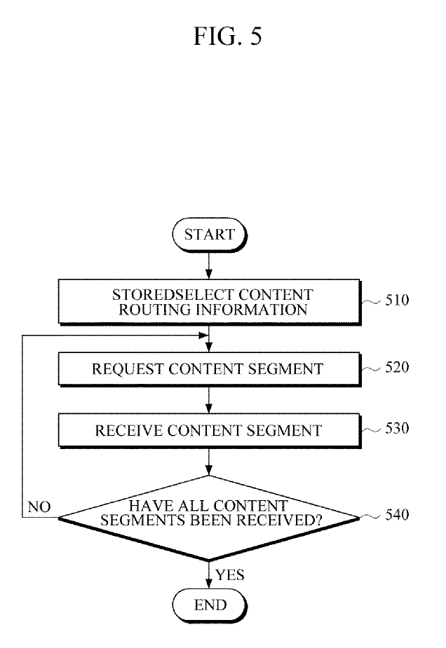

FIG. 5 is a flow chart illustrating a method for delivering segmented content in a user device according to an exemplary embodiment of the present invention.

Referring to FIG. 5, a user device selects CDN servers in which content segments of desired content in operation 510 are stored. This search operation is performed when the user device obtains content routing information from a service request routing system.

In addition, in operation 520, the user device requests the content segments of the content from the CDN servers in which the content segments are stored. In operation 530, the user device receives the requested content segments from the corresponding CDN servers. In operation 540, the user device determines whether the whole content requested by a user has been received.

If the determination result of operation 540 shows that all of the content segments of the desired content have not received, operation 510 is performed until all of the content segments are received.

According to an exemplary embodiment of the present invention, operations 520 and 530 may be performed in two ways. For example, the user device may perform operations 520 and 530 in a sequence of content segments sequentially. That is, after the first content segment is received, the second content segment may be requested and received.

In the other example, the user device may simultaneously perform operations 520 and 530 with respect to each of content segments. That is, the first content segment and the second content segment may be simultaneously requested and received.

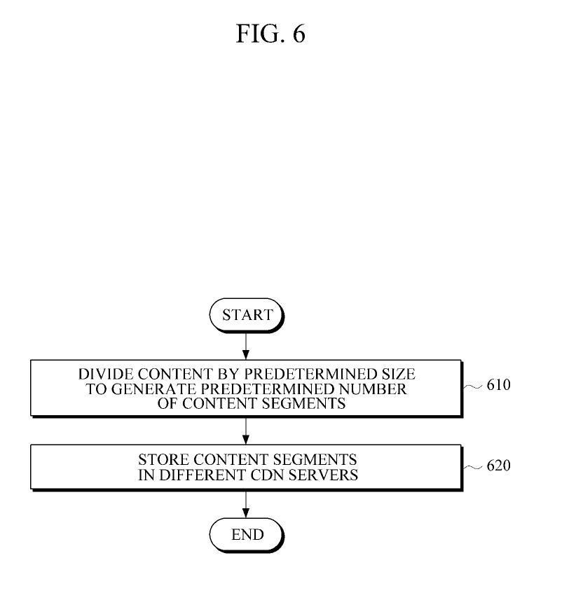

FIG. 6 is a flowchart illustrating a method for storing content segments according to an exemplary embodiment of the present invention.

Referring to FIG. 6, content is divided by a predetermined size in operation 610. That is, the predetermined number of content segments is generated to have a predetermined size with respect to the content.

In operation 620, the generated content segments are distributed and stored in different CDN servers. At this time, the first segment of the content is stored in every CDN server while other segments are stored in different CDN servers without redundancy. In this way, the present invention is able to store content more efficiently than the related art in which one content server stores content as a whole.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing content routing information to deliver content in a service request routing system within a network comprising one or more Content Delivery Network (CDN) servers in which segmented content is distributed and stored, the method comprising:
receiving a content request message from a user device;
searching for one or more CDN servers in which content segments of requested content are distributed and stored; and
delivering content routing information such as IP addresses of the one or more found CDN servers and information about the content segments to the user device.

2. A method for delivering content, the method comprising:
searching for the CDN servers in which content segments of desired content are distributed and stored;
requesting the content segments from each of the found CDN servers; and
receiving the content segments from the found CDN servers.

3. A system for delivering content comprising;
Content Delivery Network (CDN) servers configured to respectively store content segments of content, and, in response to receiving a content request including content routing information from a user device, deliver corresponding content segments to the user device; and
a service request routing system configured to store and manage the content routing information such as IP addresses of the CDN servers and information about the content segments, in which the content segments are stored respectively, and, in response to the content request received from the user device, transmit the content routing information to the user device.

4. The system of claim 3, wherein all of the CDN servers redundantly store a first content segment of the content.

5. The system of claim 3, wherein the content routing information includes addresses of the CDN servers, a content title, a content playback range and a title of a content segment, etc.

6. The method for storing a content segment in a Content Delivery Network (CDN) server, the method comprising:
dividing content by a predetermined size to generate a predetermined number of content segments; and
storing the predetermined number of content segments in a predetermined number of CDN servers without redundancy.
